(19) United States
(12) Patent Application Publication
(10) Pub. No.: US 2020/0127863 A1
(43) Pub. Date: Apr. 23, 2020

(54) POWER TRANSMISSION SYSTEM, TRANSMISSION DEVICE, AND RECEPTION DEVICE

(71) Applicant: MITSUBISHI ELECTRIC CORPORATION, Tokyo (JP)

(72) Inventor: Yusuke SUZUKI, Tokyo (JP)

(73) Assignee: MITSUBISHI ELECTRIC CORPORATION, Tokyo (JP)

(21) Appl. No.: 16/609,856

(22) PCT Filed: Jul. 4, 2017
(86) PCT No.: PCT/JP2017/024497

§ 371 Date: Oct. 31, 2019

(51) Int. Cl. H04L 12/10; H02J 1/06; H02M 3/28

(52) U.S. Cl. CPC H04L 12/10; H02M 3/28; H02J 1/06

(57) ABSTRACT

A transmission device includes: a pulse transformer including a primary winding connected to a PHY and a secondary winding connected to one end of a twisted pair wire; a pulse transformer including a primary winding connected to the PHY and a secondary winding connected to one end of a twisted pair wire; and an isolated DC/AC converter for converting a DC voltage into a pulse voltage and outputting the pulse voltage, the isolated DC/AC converter including a pair of output terminals, one of the output terminals connected to the middle point of the secondary winding of the pulse transformer, the other output terminal connected to the middle point of the secondary winding of the pulse transformer, and the reception device includes: a pulse transformer including a primary winding connected to the other end of the twisted pair wire and a secondary winding connected to a PHY; a pulse transformer including a primary winding connected to the other end of the twisted pair wire and a secondary winding connected to the PHY; and an isolated AC/DC converter for converting an input pulse voltage into a DC voltage, the isolated AC/DC converter including a pair of input terminals, one of the input terminals connected to the middle point of the primary winding of the pulse transformer, the other input terminal connected to the middle point of the primary winding of the pulse transformer.

### TECHNICAL FIELD

The present invention relates to a power transmission system, a transmission device, and a reception device for transmitting power using a communication line.

### BACKGROUND ART

Technology for transmitting power to a remote device using a communication line is known, and for example PoE (power over Ethernet (registered trademark): technology for transmitting power using an Ethernet (registered trademark, hereinafter omitted) cable) is known (see, for example, Patent Literature 1). In PoE, DC power is transmitted from a transmission device to a device via two twisted pair wires of an Ethernet cable and a reception device. Exemplary devices include VoIP phones, WLAN transmitters, and security cameras. In addition, a communication signal that is a differential signal can be transmitted through the Ethernet cable. Standards for PoE are defined in IEEE 802.3.

Meanwhile, in a power transmission system using an Ethernet cable, a transmission device includes a pulse transformer for electrically isolating the inside of the transmission device and the Ethernet cable from each other, for transmission of communication signals. Therefore, in the power transmission system, it is necessary in the transmission device to insulate the inside of the transmission device and the Ethernet cable from each other, also for power transmission. The same applies also to the reception device. Therefore, in conventional power transmission systems, a transmission device includes an isolated DC/DC converter and a power sourcing equipment (PSE) controller, and a reception device includes a powered device (PD) controller and an isolated DC/DC converter. The PSE controller performs complicated control such as detection of the PD controller, classification of the PD controller, and management of power supply to the PD controller.

### CITATION LIST

### Patent Literature

Patent Literature 1: JP 2015-180046 A

### SUMMARY OF INVENTION

### Technical Problem

As described above, the conventional power transmission systems have a disadvantage that it is necessary to use a PSE controller and a PD controller.

The present invention has been made to solve the above-described disadvantage, and it is an object of the present invention to provide a power transmission system that enables power transmission using a communication line without using a PSE controller and a PD controller.

### Solution to Problem

A power transmission system according to the present invention includes a transmission device and a reception device, in which the transmission device includes: a first communication unit for outputting a communication signal; a first pulse transformer including a first primary winding connected to the first communication unit and a first secondary winding connected to one end of a first communication line; a second pulse transformer including a second primary winding connected to the first communication unit and a second secondary winding connected to one end of a second communication line; and an isolated-type first converter for converting a DC voltage into a pulse voltage and outputting the pulse voltage, the isolated-type first converter including a pair of output terminals, one of the output terminals connected to a middle point of the first secondary winding, the other output terminal connected to a middle point of the second secondary winding, and the reception device includes: a third pulse transformer including a third primary winding connected to another end of the first communication line and a third secondary winding; a fourth pulse transformer including a fourth primary winding connected to another end of the second communication line and a fourth secondary winding; a second communication unit for receiving input of the communication signal, the second communication unit connected with the third secondary winding and the fourth secondary winding; and an isolated-type second converter for converting an input pulse voltage into a DC voltage, the isolated-type second converter including a pair of input terminals, one of the input terminals connected to a middle point of the third primary winding, the other input terminal connected to a middle point of the fourth primary winding.

### Advantageous Effects of Invention

The invention configured as the above enables power transmission using a communication line without using a PSE controller and a PD controller.

### BRIEF DESCRIPTION OF DRAWINGS

FIG. 1 is a schematic circuit diagram illustrating a configuration example of a power transmission system according to a first embodiment of the present invention.

FIG. 2 is a schematic circuit diagram illustrating a configuration example of a power transmission system according to a second embodiment of the present invention.

### DESCRIPTION OF EMBODIMENTS

Hereinafter, embodiments of the invention will be described in detail with reference to the drawings.

### First Embodiment

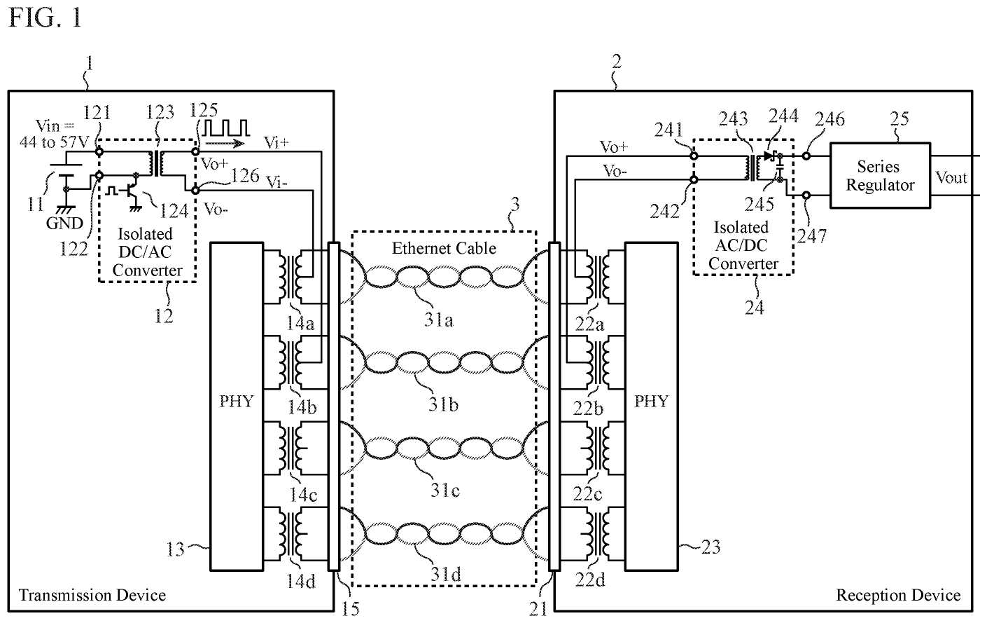

FIG. 1 is a schematic circuit diagram illustrating a configuration example of a power transmission system according to a first embodiment of the present invention. Hereinafter, a case where the power transmission system performs power transmission by using PoE will be described.

The power transmission system transmits power using an Ethernet cable (communication cable) 3. The Ethernet cable 3 includes a plurality of twisted pair wires (communication lines) 31. The Ethernet cable 3 illustrated in FIG. 1 includes four twisted pair wires 31a to 31d. As the Ethernet cable 3, for example, a standard CAT-5 cable can be used. The power transmission system includes a transmission device 1 and a reception device 2 as illustrated in FIG. 1.

The transmission device 1 transmits power using the Ethernet cable 3. As illustrated in FIG. 1, the transmission device 1 includes a DC power supply 11, an isolated DC/AC converter (first converter) 12, a PHY (first communication unit) 13, a plurality of pulse transformers 14, and a connector 15. In the transmission device 1 illustrated in FIG. 1, four pulse transformers 14a to 14d are used.

The DC power supply 11 outputs a direct current voltage (DC voltage). The DC voltage Vin output from the DC power supply 11 has a value in a range of 44 V to 57 V, for example. The DC power supply 11 has a positive terminal connected to an input terminal 121 of the isolated DC/AC converter 12 and a negative terminal connected to GND and to an input terminal 122 of the isolated DC/AC converter 12.

The isolated DC/AC converter 12 is an isolated-type converter that converts an input DC voltage into a pulse voltage (AC voltage) and outputs the pulse voltage. Note that although AC voltage is generally classified into various groups depending on the shape of the waveform such as the voltage of a sine waveform (sine waveform), a triangular waveform, or a square waveform (pulse waveform), it is assumed here the AC voltage refers to a voltage of a square waveform (pulse waveform). The isolated DC/AC converter 12 includes the pair of input terminals 121 and 122, a pulse transformer 123, a switching transistor 124, and a pair of output terminals 125 and 126, for example as illustrated in FIG. 1.

The pulse transformer 123 includes a primary winding and a secondary winding. The pulse transformer 123 electrically insulates the input side which is the primary winding side and the output side which is the secondary winding side from each other. The primary winding has one end connected to the input terminal 121 and the other end connected to the input terminal 122. The secondary winding has one end connected to the output terminal (Vo+) 125 and the other end connected to the output terminal (Vo−) 126.

The switching transistor 124 performs switching operation on a basis of a pulse signal input to the gate terminal. The switching transistor 124 has an emitter terminal connected to the other end of the primary winding of the pulse transformer 123, and a collector terminal connected to GND. The switching transistor 124 converts the DC voltage output from the DC power supply 11 into a pulse voltage.

The PHY 13 is a communication interface for outputting a communication signal. Note that the communication signal is a differential signal.

The pulse transformer (second pulse transformer) 14a includes a primary winding (second primary winding) connected to the PHY 13 and a secondary winding (second secondary winding) connected to the connector 15. The pulse transformer 14a electrically insulates the input side which is the primary winding side and the output side which is the secondary winding side from each other. The pulse transformer 14a is further connected with the output terminal 126 of the isolated DC/AC converter 12 at the middle point (Vi−) of the secondary winding.

The pulse transformer (first pulse transformer) 14b includes a primary winding (first primary winding) connected to the PHY 13 and a secondary winding (first secondary winding) connected to the connector 15. The pulse transformer 14b electrically insulates the input side which is the primary winding side and the output side which is the secondary winding side from each other. The pulse transformer 14b is further connected with the output terminal 125 of the isolated DC/AC converter 12 at the middle point (Vi+) of the secondary winding.

The pulse transformer 14c includes a primary winding connected to the PHY 13 and a secondary winding connected to the connector 15. The pulse transformer 14c electrically insulates the input side that is the primary winding side and the output side that is the secondary winding side from each other.

The pulse transformer 14d includes a primary winding connected to the PHY 13 and a secondary winding connected to the connector 15. The pulse transformer 14d electrically insulates the input side that is the primary winding side and the output side that is the secondary winding side from each other.

The connector 15 includes a plurality of output pins, and connects the Ethernet cable 3 connected to the output pins to the pulse transformers 14. The connector 15 illustrated in FIG. 1 includes eight output pins. In FIG. 1, the connector 15 connects the pulse transformer 14a and one end of the twisted pair wire (second communication line) 31a, connects the pulse transformer 14b and one end of the twisted pair wire (first communication line) 31b, connects the pulse transformer 14c and one end of the twisted pair wire 31c, and connects the pulse transformer 14d and one end of the twisted pair wire 31d. As the connector 15, for example, an RJ45 connector can be used.

The reception device 2 receives power using the Ethernet cable 3. As illustrated in FIG. 1, the reception device 2 includes a connector 21, a plurality of pulse transformers 22, a PHY (second communication unit) 23, an isolated AC/DC converter 24 (rectifier circuit, second converter), and a series regulator 25. In the reception device 2 illustrated in FIG. 1, four pulse transformers 22a to 22d are used.

The connector 21 has a plurality of input pins, and connects the Ethernet cable 3 connected to the input pins to the pulse transformers 22. The connector 21 illustrated in FIG. 1 includes eight input pins. In FIG. 1, the connector 21 connects the pulse transformer 22a and the other end of the twisted pair wire 31a, connects the pulse transformer 22b and the other end of the twisted pair wire 31b, connects the pulse transformer 22c and the other end of the twisted pair wire 31c, and connects the pulse transformer 22d and the other end of the twisted pair wire 31d. As the connector 21, for example, an RJ45 connector can be used.

The pulse transformer (fourth pulse transformer) 22a includes a primary winding (fourth primary winding) connected to the connector 21 and a secondary winding (fourth secondary winding) connected to the PHY 23. The pulse transformer 22a electrically insulates the input side which is the primary winding side and the output side which is the secondary winding side from each other. The pulse transformer 22a is further connected with an input terminal 242 of the isolated AC/DC converter 24 at the middle point (Vo−) of the primary winding.

The pulse transformer (third pulse transformer) 22b includes a primary winding (third primary winding) connected to the connector 21 and a secondary winding (third secondary winding) connected to the PHY 23. The pulse transformer 22b electrically insulates the input side which is the primary winding side and the output side which is the secondary winding side from each other. The pulse transformer 22b is further connected with an input terminal 241 of the isolated AC/DC converter 24 at the middle point (Vo+) of the primary winding.

The pulse transformer 22c includes a primary winding connected to the connector 21 and a secondary winding connected to the PHY 23. The pulse transformer 22c electrically insulates the input side that is the primary winding side and the output side that is the secondary winding side from each other.

The pulse transformer 22d includes a primary winding connected to the connector 21 and a secondary winding connected to the PHY 23. The pulse transformer 22d electrically insulates the input side that is the primary winding side and the output side that is the secondary winding side from each other.

The PHY 23 is a communication interface to which a communication signal is input.

The isolated AC/DC converter 24 is an isolated-type converter that converts an input pulse voltage into a DC voltage and outputs the DC voltage. For example as illustrated in FIG. 1, the isolated AC/DC converter 24 includes the pair of input terminals 241 and 242, a flyback transformer 243, a rectifier diode 244, an output capacitor 245, and a pair of output terminals 246 and 247.

The flyback transformer 243 includes a primary winding and a secondary winding. The flyback transformer 243 electrically insulates the input side that is the primary winding side and the output side that is the secondary winding side from each other. The primary winding has one end connected to the input terminal 241 and the other end connected to the input terminal 242. The secondary winding has one end connected to an anode of the rectifier diode 244 and the other end connected to the output terminal 247.

The rectifier diode 244 has a cathode connected to the output terminal 246.

The output capacitor 245 has one end connected to the cathode of the rectifier diode 244 and the other end connected to the other end of the secondary winding of the flyback transformer 243.

The rectifier diode 244 and the output capacitor 245 convert the pulse voltage output by the pulse transformers 22a and 22b into a DC voltage.

The series regulator 25 is connected to the pair of output terminals 246 and 247 of the isolated AC/DC converter 24, and steps down the input pulse voltage. The series regulator 25 stabilizes the pulse voltage output by the isolated AC/DC converter 24. Note that the series regulator 25 is not an essential component, and may be removed from the power transmission system in a case where the accuracy in the voltage is not required.

Next, exemplary operation of the power transmission system according to the first embodiment of the present invention will be described.

In the transmission device 1, the isolated DC/AC converter 12 generates and outputs a pulse voltage on the basis of the DC voltage output from the DC power supply 11. Of the pair of output terminals 125 and 126 of the isolated DC/AC converter 12, the output terminal 125 is connected to the middle point of the secondary winding of the pulse transformer 14b, and the output terminal 126 is connected to the middle point of the secondary winding of the pulse transformer 14a. As a result, a pulse potential difference is generated between midpoint potentials of the two respective twisted pair wires 31a and 31b, thereby implementing power transmission using the Ethernet cable 3.

In the reception device 2, the isolated AC/DC converter 24 receives the pulse voltage transmitted by the twisted pair wires 31a and 31b via the pulse transformers 22a and 22b and converts the pulse voltage into a DC voltage. Thereafter, the DC voltage is stabilized by the series regulator 25 and then supplied to a subsequent circuit.

Meanwhile, a communication signal output by the PHY 13 is also transmitted to the PHY 23 via the pulse transformers 14 and 22 and the Ethernet cable 3. Here, the communication signal is a differential signal. In differential signals, even when a midpoint potential varies, the variation is canceled in principle. Therefore, transmission of the pulse voltage does not affect the quality of the communication signal.

Note that if there is a difference in the wiring length between lines for transmitting the pulse voltage and the communication signal, a variation in the midpoint potential due to transmission of the pulse voltage is converted into common mode noise, which may adversely affect the quality of the communication signal.

For this reason, it is necessary that the frequency bandwidth of the pulse voltage output from the isolated DC/AC converter 12 does not overlap with the frequency bandwidth of the communication signal. Let the frequency bandwidth of the pulse voltage be Fw, rising time of the pulse voltage be Tr, and falling time be Tf, then Fw=0.35/Tr holds where Tr≤Tf, and Fw=0.35/Tf holds where Tr>Tf. Therefore, in the isolated DC/AC converter 12, by setting the rising time and the falling time of the pulse voltage to be long to some extent, it is possible to prevent the frequency bandwidth of the pulse voltage from overlapping with the frequency bandwidth of the communication signal. This can be achieved by adjusting rising time and falling time in the switching transistor 124. As an example, the rising time and the falling time can be delayed by adding a capacitance component to the switching transistor 124.

Note that the value of the DC voltage output from the reception device 2 is determined by the frequency (switching frequency in the switching transistor 124) and the duty ratio of the pulse voltage. In the power transmission system according to the first embodiment, the switching transistor 124 cannot be controlled by feeding back the value of the DC voltage output from the reception device 2 to the transmission device 1. Meanwhile, in a case where the accuracy in the voltage is required, a DC voltage with high accuracy can be generated by using the series regulator 25.

As described above, according to the first embodiment, the transmission device 1 includes: the PHY 13 for outputting a communication signal; the pulse transformer 14b including a primary winding connected to the PHY 13 and a secondary winding connected to one end of the twisted pair wire 31b; the pulse transformer 14a including a primary winding connected to the PHY 13 and a secondary winding connected to one end of the twisted pair wire 31a; and the isolated DC/AC converter 12 for converting a DC voltage into a pulse voltage and outputting the pulse voltage, the isolated DC/AC converter 12 including the pair of output terminals 125 and 126, one of the output terminals connected to the middle point of the secondary winding of the pulse transformer 14b, the other output terminal connected to the middle point of the secondary winding of the pulse transformer 14a, and the reception device 2 includes: the pulse transformer 22b including a primary winding connected to the other end of the twisted pair wire 31b and a secondary winding; the pulse transformer 22a including a primary winding connected to the other end of the twisted pair wire 31a and a secondary winding; the PHY 23 for receiving input of the communication signal, the PHY 23 connected with the secondary winding of the pulse transformer 22b and the secondary winding of the pulse transformer 22a; and the isolated AC/DC converter 24 for converting an input pulse voltage into a DC voltage, the isolated AC/DC converter 24 including the pair of input terminals 241 and 242, one of the input terminals connected to the middle point of the primary winding of the pulse transformer 22b, the other input terminal connected to the middle point of the primary winding of the pulse transformer 22a. Therefore, it is possible to transmit power using a communication line without performing complicated control by a PSE controller such as detection of a PD controller, classification of the PD controller, and management of power supply to the PD controller, that is, without using a PSE controller and a PD controller. Therefore, a power transmission system can be configured by a simple circuit configuration compared to the conventional configuration, and thus cost reduction can be achieved.

Note that the case where power transmission is performed using the Ethernet cable 3 used in the conventional PoE as the communication cable has been illustrated in the above description. However, it is not limited thereto, and a general-purpose cable, a coaxial cable, or the like may be used as the communication cable, thereby obtaining similar effects as described above.

### Second Embodiment

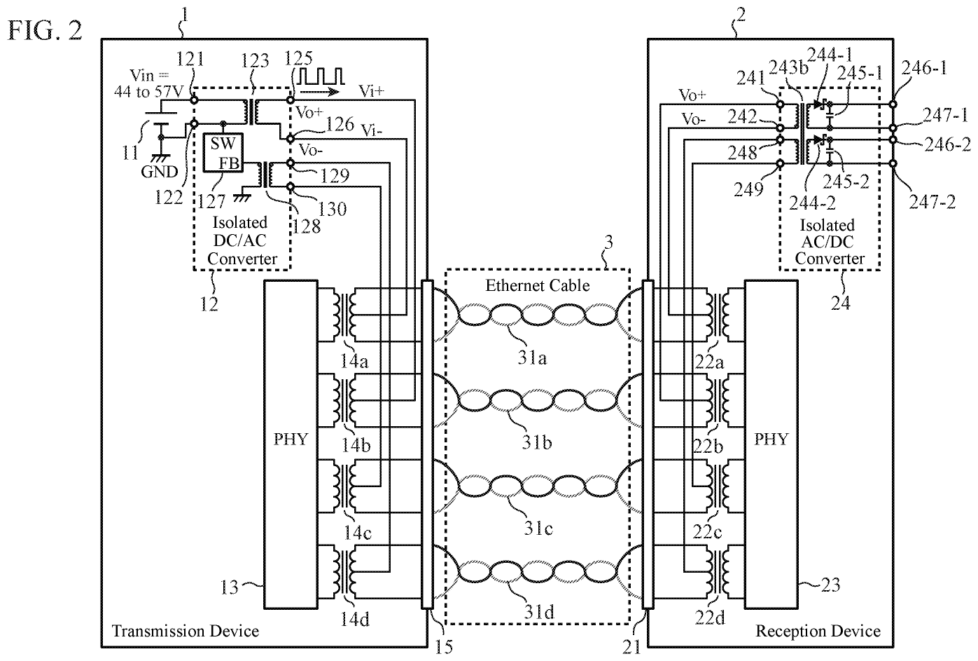

FIG. 2 is a schematic circuit diagram illustrating a configuration example of a power transmission system according to a second embodiment of the present invention. In the power transmission system according to the second embodiment illustrated in FIG. 2, as compared to the power transmission system according to the first embodiment illustrated in FIG. 1, the series regulator 25 is removed, the switching transistor 124 is replaced by a converter circuit 127, the flyback transformer 243 is replaced by a flyback transformer 243b, rectifier diodes 244, output capacitors 245, and output terminals 246 and 247 of a plurality of systems are included, and a pulse transformer 128, a pair of input terminals 129 and 130, and a pair of output terminals 248 and 249 are added. Other configuration in the power transmission system according to the second embodiment illustrated in FIG. 2 is similar to that of the power transmission system according to the first embodiment illustrated in FIG. 1, and thus the same symbols are used whereas description will be given to only the different parts. In FIG. 2, two systems of the rectifier diodes 244, the output capacitors 245, and the output terminals 246 and 247 are illustrated while suffixes (−1, −2) corresponding to the respective systems are added.

The converter circuit 127 has, in addition to the function of the switching transistor 124, a function of controlling, on the basis of an input reference voltage, the frequency (switching frequency) and the duty ratio of a pulse voltage to be generated. As this converter circuit 127, a commercially available product can be used.

The pulse transformer 128 includes a primary winding and a secondary winding. The pulse transformer 128 electrically insulates the input side which is the primary winding side and the output side which is the secondary winding side from each other. The primary winding has one end connected to the middle point of the secondary winding of the pulse transformer 14d via the input terminal 129 and the other end connected to the middle point of the secondary winding of the pulse transformer 14c via the input terminal 130. The secondary winding has one end connected to the converter circuit 127, and the other end connected to GND.

The flyback transformer 243b includes a primary winding, secondary windings of a plurality of systems, and a tertiary winding. The flyback transformer 243b electrically insulates the input side that is the primary winding side, an output side that is the secondary windings side, and an output side that is the tertiary winding side from each other. The flyback transformer 243b illustrated in FIG. 2 includes the secondary windings of two systems. The primary winding has one end connected to the input terminal 241 and the other end connected to the input terminal 242. The secondary windings each have one end connected to an anode of a rectifier diode 244 of a corresponding system, and the other end connected to an output terminal 247 of the corresponding system. The tertiary winding has one end connected to the middle point of the primary winding of the pulse transformer 22d via the output terminal 248, and the other end connected to the middle point of the primary winding of the pulse transformer 22c via the output terminal 249.

Note that the rectifier diodes 244 and the output capacitors 245 of the respective systems convert pulse voltages output by the pulse transformers 22a and 22b into DC voltages different from each other.

Next, the operation of the power transmission system according to the second embodiment of the present invention will be described.

In the transmission device 1, the isolated DC/AC converter 12 generates and outputs a pulse voltage on the basis of the DC voltage output from the DC power supply 11. Of the pair of output terminals 125 and 126 of the isolated DC/AC converter 12, the output terminal 125 is connected to the middle point of the secondary winding of the pulse transformer 14b, and the output terminal 126 is connected to the middle point of the secondary winding of the pulse transformer 14a. As a result, a pulse potential difference is generated between midpoint potentials of the two respective twisted pair wires 31a and 31b, thereby implementing power transmission using the Ethernet cable 3.

In the reception device 2, the isolated AC/DC converter 24 receives the pulse voltage transmitted by the twisted pair wires 31a and 31b via the pulse transformers 22a and 22b and converts the pulse voltage into a DC voltage.

Here, the flyback transformer 243b includes the plurality of secondary windings, and two types of pulse voltages are generated by the secondary windings of the two systems in FIG. 2. These two types of pulse voltages are converted into respective DC voltages different from each other, and then supplied to subsequent circuits. Moreover, adding a secondary winding can increase the type of DC voltage that the reception device 2 can output.

The flyback transformer 243b has the tertiary winding. The tertiary winding has one end connected to the middle point of the primary winding of the pulse transformer 22d, and the other end connected to the middle point of the primary winding of the pulse transformer 22c. As a result, a reference potential difference for monitoring the value of the pulse voltage applied to the flyback transformer 243b, is generated between the midpoint potentials of the two twisted pair wires 31c and 31d, and the reference voltage transmitted by the twisted pair wires 31c and 31d are fed back to the converter circuit 127 via the pulse transformer 128.

The value of the DC voltage output from the isolated AC/DC converter 24 is controlled by adjustment of the frequency and the duty ratio of the pulse voltage based on the reference voltage by the converter circuit 127. As a result, the isolated AC/DC converter 24 can output DC voltages with high accuracy.

As described above, according to the second embodiment, the isolated DC/AC converter 12 controls the frequency and the duty ratio of the pulse voltage to be output on the basis of the pulse voltage having been input to the isolated AC/DC converter 24, and thus, in addition to the effects of the first embodiment, highly accurate DC voltages can be output without using the series regulator 25.

Note that, in the above description, the case has been described in which the secondary windings of the plurality of systems are included in the flyback transformer 243b and the isolated AC/DC converter 24 converts the input pulse voltage into a plurality of DC voltages. However, it is not limited thereto, and a single secondary winding may be used in the flyback transformer 243b.

Note that the present invention may include a flexible combination of the embodiments, a modification of any component of each of the embodiments, or an omission of any component in each of the embodiments within the scope of the present invention.

### INDUSTRIAL APPLICABILITY

A power transmission system according to the present invention enables power transmission using a communication line without using a PSE controller and a PD controller, and is suitable for use in a power transmission system for transmitting power using a communication line.

### REFERENCE SIGNS LIST

1: transmission device, 2: reception device, 3: Ethernet cable, 11: DC power supply, 12: isolated DC/AC converter (first converter), 13: PHY (first communication unit), 14: pulse transformer, 15: connector, 21: connector, 22: pulse transformer, 23: PHY (second communication unit), 24: isolated AC/DC converter (rectifier circuit, first converter), 25: series regulator, 31: twisted pair wire (communication line), 121, 122: input terminal, 123: pulse transformer, 124: switching transistor, 125, 126: output terminal, 127: converter circuit, 128: pulse transformer, 241, 242: input terminal, 243, 243b: flyback transformer, 244: rectifier diode, 245: output capacitor, 246, 247: output terminal.

1. A power transmission system comprising:
a transmission device; and
a reception device,
wherein the transmission device includes:
first communication circuitry to output a communication signal;
a first pulse transformer including a first primary winding connected to the first communication circuitry and a first secondary winding connected to one end of a first communication line;
a second pulse transformer including a second primary winding connected to the first communication circuitry and a second secondary winding connected to one end of a second communication line; and
an isolated-type first converter to convert a DC voltage into a pulse voltage and output the pulse voltage, the isolated-type first converter including a pair of output terminals, one of the output terminals connected to a middle point of the first secondary winding, the other output terminal connected to a middle point of the second secondary winding, and
the reception device includes:
a third pulse transformer including a third primary winding connected to another end of the first communication line and a third secondary winding;
a fourth pulse transformer including a fourth primary winding connected to another end of the second communication line and a fourth secondary winding;
second communication circuitry to receive input of the communication signal, the second communication circuitry connected with the third secondary winding and the fourth secondary winding; and
an isolated-type second converter to convert an input pulse voltage into a DC voltage, the isolated-type second converter including a pair of input terminals, one of the input terminals connected to a middle point of the third primary winding, the other input terminal connected to a middle point of the fourth primary winding.

2. The power transmission system according to claim 1,
wherein rising time and falling time of a pulse voltage to be output are adjusted in the first converter in such a manner that a frequency bandwidth of the pulse voltage does not overlap with a frequency bandwidth of the communication signal output by the first communication circuitry.

3. The power transmission system according to claim 1,
wherein the first converter controls a frequency and a duty ratio of a pulse voltage to be output, on a basis of the pulse voltage input to the second converter.

4. The power transmission system according to claim 1,
wherein the second converter converts the input pulse voltage into a plurality of DC voltages.

5. A transmission device comprising:
first communication circuitry to output a communication signal;
a first pulse transformer including a first primary winding connected to the first communication circuitry and a first secondary winding connected to one end of a first communication line;
a second pulse transformer including a second primary winding connected to the first communication circuitry and a second secondary winding connected to one end of a second communication line; and
an isolated-type first converter to convert a DC voltage into a pulse voltage and output the pulse voltage, the isolated-type first converter including a pair of output terminals, one of the output terminals connected to a middle point of the first secondary winding, the other output terminal connected to a middle point of the second secondary winding.

6. A reception device comprising:
a third pulse transformer including a third primary winding connected to another end of a first communication line and a third secondary winding;
a fourth pulse transformer including a fourth primary winding connected to another end of a second communication line and a fourth secondary winding;
second communication circuitry to receive input of a communication signal, the second communication circuitry connected with the third secondary winding and the fourth secondary winding; and
an isolated-type second converter to convert an input pulse voltage into a DC voltage, the isolated-type second converter including a pair of input terminals, one of the input terminals connected to a middle point of the third primary winding, the other input terminal connected to a middle point of the fourth primary winding.
